(19) United States
(12) Patent Application Publication
(10) Pub. No.: US 2020/0366440 A1
(43) Pub. Date: Nov. 19, 2020

(54) LONG TERM EVOLUTION COMMON REFERENCE SIGNAL-ASSISTED NEW RADIO TRACKING

(71) Applicant: QUALCOMM Incorporated, San Diego, CA (US)

(72) Inventors: Shiau-He Tsai, San Diego, CA (US); Parisa Cheraghi, San Diego, CA (US); Hari Sankar, San Diego, CA (US); Alexei Yurievitch Gorokhov, San Diego, CA (US); Paolo Minero, La Jolla, CA (US)

(21) Appl. No.: 16/874,407

(22) Filed: May 14, 2020

Related U.S. Application Data
(60) Provisional application No. 62/849,550, filed on May 17, 2019.

(51) Int. Cl. H04L 5/00; H04W 72/04; H04W 4/029

(52) U.S. Cl. CPC H04L 5/0051; H04W 4/029; H04W 72/04

(57) ABSTRACT

Long term evolution (LTE) common reference signal (CRS)-assisted new radio (NR) tracking operations are disclosed. A user equipment (UE) may obtain a colocation indication identifying a quasi-colocation (QCL) status of a legacy network downlink antenna associated with one or more cell-specific reference signal (CRS) resource elements (REs) and an advanced network downlink antenna in communication with the UE. The UE may then perform a tracking loop operation for the advanced network using the one or more CRS REs of the legacy network in response to the QCL status indicating a QCL state, wherein the QCL state indicates the legacy network downlink antenna is quasi-colocated with the advanced network downlink antenna.

### CROSS-REFERENCE TO RELATED APPLICATIONS

This application claims priority to co-pending U.S. Provisional Application No. 62/849,550, entitled “LTE CRS-ASSISTED NR TRACKING,” filed May 17, 2019, the disclosure of which is hereby incorporated herein by reference.

### BACKGROUND

### Field

Aspects of the present disclosure relate generally to wireless communication systems, and more particularly, to long term evolution (LTE) common reference signal (CRS)-assisted new radio (NR) tracking operations.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a method of wireless communication includes obtaining, by a user equipment (UE) compatible with an advanced network, a colocation indication identifying a quasi-colocation (QCL) status of a legacy network downlink antenna associated with transmission of one or more cell-specific reference signal (CRS) resource elements (REs) and an advanced network downlink antenna in communication with the UE, wherein the advanced network and a legacy network dynamically share the time-frequency resources, and performing, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

In an additional aspect of the disclosure, an apparatus configured for wireless communication includes means for obtaining, by a UE compatible with an advanced network, a colocation indication identifying a QCL status of a legacy network downlink antenna associated with transmission of one or more CRS REs and an advanced network downlink antenna in communication with the UE, wherein the advanced network and a legacy network dynamically share the time-frequency resources, and means for performing, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

In an additional aspect of the disclosure, a non-transitory computer-readable medium having program code recorded thereon. The program code further includes code to obtain, by a UE compatible with an advanced network, a colocation indication identifying a QCL status of a legacy network downlink antenna associated with transmission of one or more CRS REs and an advanced network downlink antenna in communication with the UE, wherein the advanced network and a legacy network dynamically share the time-frequency resources, and means for code to perform, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

In an additional aspect of the disclosure, an apparatus configured for wireless communication is disclosed. The apparatus includes at least one processor, and a memory coupled to the processor. The processor is configured to obtain, by a UE compatible with an advanced network, a colocation indication identifying a QCL status of a legacy network downlink antenna associated with transmission of one or more CRS REs and an advanced network downlink antenna in communication with the UE, wherein the advanced network and a legacy network dynamically share the time-frequency resources, and means for to perform, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3 is a block diagram illustrating a wireless communication system including base stations that use directional wireless beams.

FIG. 4 is a block diagram illustrating a portion of a communication network employing dynamic spectrum sharing between LTE operations and NR operations.

FIG. 5 is a block diagram illustrating example blocks executed to implement aspects of the present disclosure.

FIG. 6 is a block diagram illustrating a portion of a communication network employing dynamic spectrum sharing between LTE operations and NR operations conducted by an NR base station, an LTE base station, and an NR-compatible UE, each configured according to one aspect of the present disclosure.

FIGS. 7A-7C are block diagrams illustrating portions of communication networks employing dynamic spectrum sharing between LTE operations and NR operations conducted by an NR base station, an LTE base station, and an NR-compatible UE, each configured according to one aspect of the present disclosure.

FIG. 8 is a block diagram illustrating a UE configured according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

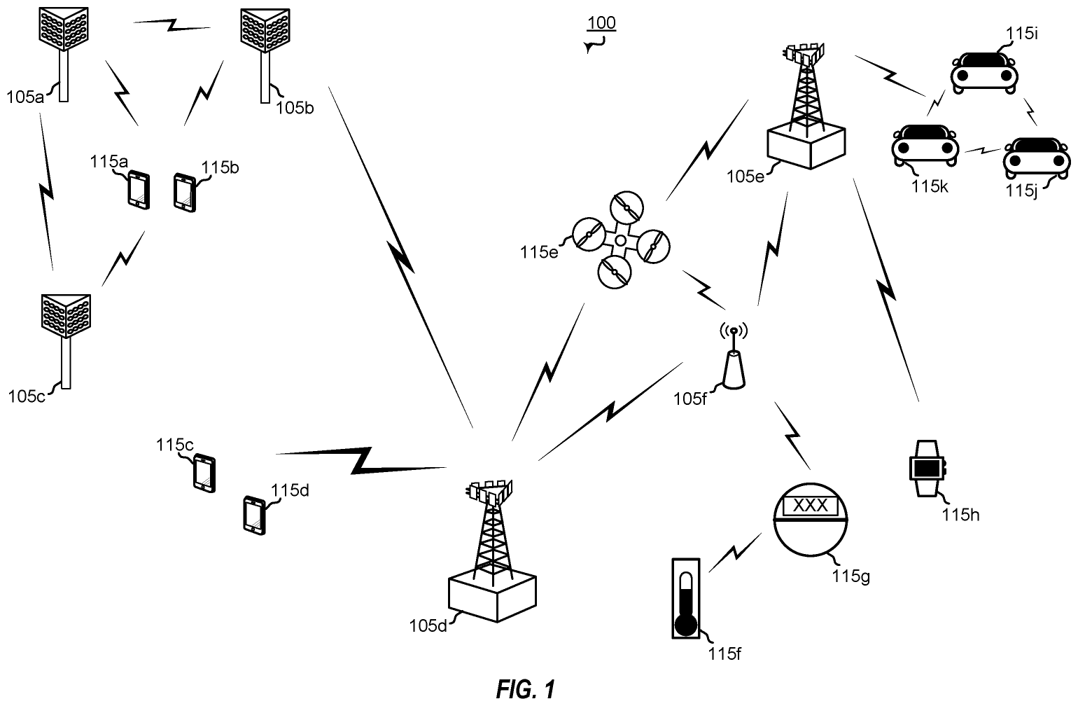

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE may be a device that includes a Universal Integrated Circuit Card (UICC). In another aspect, a UE may be a device that does not include a UICC. In some aspects, UEs that do not include UICCs may also be referred to as internet of everything (IoE) or internet of things (IoT) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations.

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

5G network 100 also support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

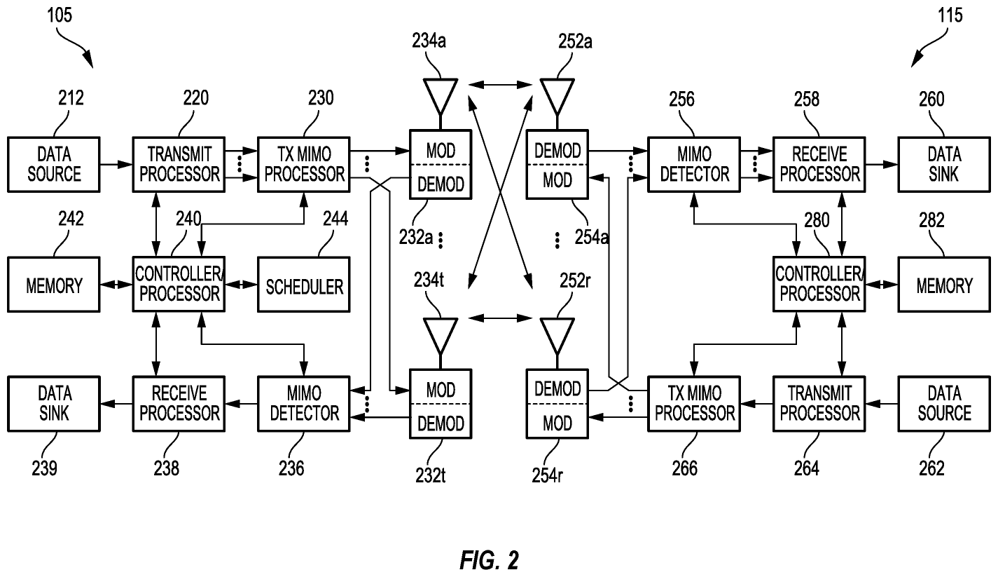

FIG. 2 shows a block diagram of a design of a base station 105 and a UE 115, which may be one of the base station and one of the UEs in FIG. 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

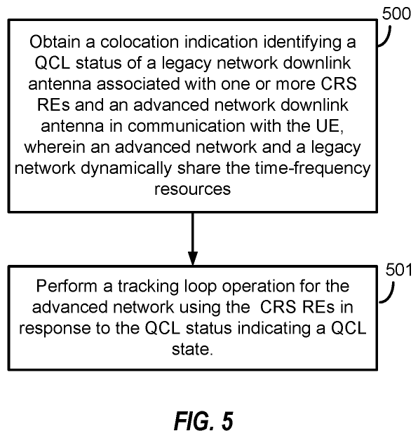

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIG. 5, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 of the 5G network 100 (in FIG. 1) may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

Use of a medium-sensing procedure to contend for access to an unlicensed shared spectrum may result in communication inefficiencies. This may be particularly evident when multiple network operating entities (e.g., network operators) are attempting to access a shared resource. In the 5G network 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

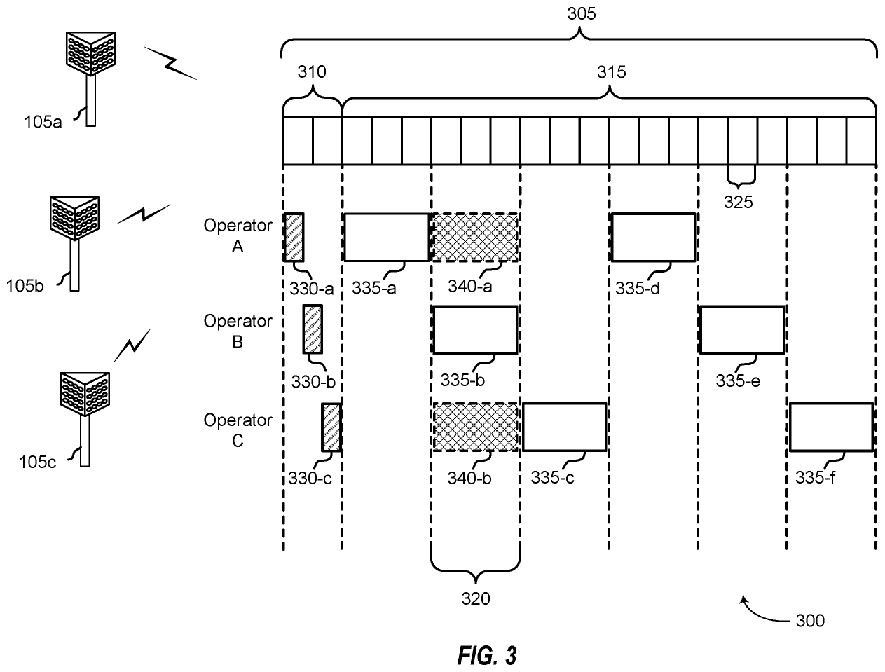

FIG. 3 illustrates an example of a timing diagram 300 for coordinated resource partitioning. The timing diagram 300 includes a superframe 305, which may represent a fixed duration of time (e.g., 20 ms). The superframe 305 may be repeated for a given communication session and may be used by a wireless system such as 5G network 100 described with reference to FIG. 1. The superframe 305 may be divided into intervals such as an acquisition interval (A-INT) 310 and an arbitration interval 315. As described in more detail below, the A-INT 310 and arbitration interval 315 may be subdivided into sub-intervals, designated for certain resource types, and allocated to different network operating entities to facilitate coordinated communications between the different network operating entities. For example, the arbitration interval 315 may be divided into a plurality of sub-intervals 320. Also, the superframe 305 may be further divided into a plurality of subframes 325 with a fixed duration (e.g., 1 ms). While timing diagram 300 illustrates three different network operating entities (e.g., Operator A, Operator B, Operator C), the number of network operating entities using the superframe 305 for coordinated communications may be greater than or fewer than the number illustrated in timing diagram 300.

The A-INT 310 may be a dedicated interval of the superframe 305 that is reserved for exclusive communications by the network operating entities. In some examples, each network operating entity may be allocated certain resources within the A-INT 310 for exclusive communications. For example, resources 330-a may be reserved for exclusive communications by Operator A, such as through base station 105a, resources 330-b may be reserved for exclusive communications by Operator B, such as through base station 105b, and resources 330-c may be reserved for exclusive communications by Operator C, such as through base station 105c. Since the resources 330-a are reserved for exclusive communications by Operator A, neither Operator B nor Operator C can communicate during resources 330-a, even if Operator A chooses not to communicate during those resources. That is, access to exclusive resources is limited to the designated network operator. Similar restrictions apply to resources 330-b for Operator B and resources 330-c for Operator C. The wireless nodes of Operator A (e.g, UEs 115 or base stations 105) may communicate any information desired during their exclusive resources 330-a, such as control information or data.

When communicating over an exclusive resource, a network operating entity does not need to perform any medium sensing procedures (e.g., listen-before-talk (LBT) or clear channel assessment (CCA)) because the network operating entity knows that the resources are reserved. Because only the designated network operating entity may communicate over exclusive resources, there may be a reduced likelihood of interfering communications as compared to relying on medium sensing techniques alone (e.g., no hidden node problem). In some examples, the A-INT 310 is used to transmit control information, such as synchronization signals (e.g., SYNC signals), system information (e.g., system information blocks (SIBs)), paging information (e.g., physical broadcast channel (PBCH) messages), or random access information (e.g., random access channel (RACH) signals). In some examples, all of the wireless nodes associated with a network operating entity may transmit at the same time during their exclusive resources.

In some examples, resources may be classified as prioritized for certain network operating entities. Resources that are assigned with priority for a certain network operating entity may be referred to as a guaranteed interval (G-INT) for that network operating entity. The interval of resources used by the network operating entity during the G-INT may be referred to as a prioritized sub-interval. For example, resources 335-a may be prioritized for use by Operator A and may therefore be referred to as a G-INT for Operator A (e.g., G-INT-OpA). Similarly, resources 335-b may be prioritized for Operator B (e.g., G-INT-OpB), resources 335-c may be prioritized for Operator C (e.g., G-INT-OpC), resources 335-d may be prioritized for Operator A, resources 335-e may be prioritized for Operator B, and resources 335-f may be prioritized for Operator C.

The various G-INT resources illustrated in FIG. 3 appear to be staggered to illustrate their association with their respective network operating entities, but these resources may all be on the same frequency bandwidth. Thus, if viewed along a time-frequency grid, the G-INT resources may appear as a contiguous line within the superframe 305. This partitioning of data may be an example of time division multiplexing (TDM). Also, when resources appear in the same sub-interval (e.g., resources 340-a and resources 335-b), these resources represent the same time resources with respect to the superframe 305 (e.g., the resources occupy the same sub-interval 320), but the resources are separately designated to illustrate that the same time resources can be classified differently for different operators.

When resources are assigned with priority for a certain network operating entity (e.g., a G-INT), that network operating entity may communicate using those resources without having to wait or perform any medium sensing procedures (e.g., LBT or CCA). For example, the wireless nodes of Operator A are free to communicate any data or control information during resources 335-a without interference from the wireless nodes of Operator B or Operator C.

A network operating entity may additionally signal to another operator that it intends to use a particular G-INT. For example, referring to resources 335-a, Operator A may signal to Operator B and Operator C that it intends to use resources 335-a. Such signaling may be referred to as an activity indication. Moreover, since Operator A has priority over resources 335-a, Operator A may be considered as a higher priority operator than both Operator B and Operator C. However, as discussed above, Operator A does not have to send signaling to the other network operating entities to ensure interference-free transmission during resources 335-a because the resources 335-a are assigned with priority to Operator A.

Similarly, a network operating entity may signal to another network operating entity that it intends not to use a particular G-INT. This signaling may also be referred to as an activity indication. For example, referring to resources 335-b, Operator B may signal to Operator A and Operator C that it intends not to use the resources 335-b for communication, even though the resources are assigned with priority to Operator B. With reference to resources 335-b, Operator B may be considered a higher priority network operating entity than Operator A and Operator C. In such cases, Operators A and C may attempt to use resources of sub-interval 320 on an opportunistic basis. Thus, from the perspective of Operator A, the sub-interval 320 that contains resources 335-b may be considered an opportunistic interval (O-INT) for Operator A (e.g., O-INT-OpA). For illustrative purposes, resources 340-a may represent the O-INT for Operator A. Also, from the perspective of Operator C, the same sub-interval 320 may represent an O-INT for Operator C with corresponding resources 340-b. Resources 340-a, 335-b, and 340-b all represent the same time resources (e.g., a particular sub-interval 320), but are identified separately to signify that the same resources may be considered as a G-INT for some network operating entities and yet as an O-INT for others.

To utilize resources on an opportunistic basis, Operator A and Operator C may perform medium-sensing procedures to check for communications on a particular channel before transmitting data. For example, if Operator B decides not to use resources 335-b (e.g., G-INT-OpB), then Operator A may use those same resources (e.g., represented by resources 340-a) by first checking the channel for interference (e.g., LBT) and then transmitting data if the channel was determined to be clear. Similarly, if Operator C wanted to access resources on an opportunistic basis during sub-interval 320 (e.g., use an O-INT represented by resources 340-b) in response to an indication that Operator B was not going to use its G-INT (e.g., resources 335-b), Operator C may perform a medium sensing procedure and access the resources if available. In some cases, two operators (e.g., Operator A and Operator C) may attempt to access the same resources, in which case the operators may employ contention-based procedures to avoid interfering communications. The operators may also have sub-priorities assigned to them designed to determine which operator may gain access to resources if more than operator is attempting access simultaneously. For example, Operator A may have priority over Operator C during sub-interval 320 when Operator B is not using resources 335-b (e.g., G-INT-OpB). It is noted that in another sub-interval (not shown) Operator C may have priority over Operator A when Operator B is not using its G-INT.

In some examples, a network operating entity may intend not to use a particular G-INT assigned to it, but may not send out an activity indication that conveys the intent not to use the resources. In such cases, for a particular sub-interval 320, lower priority operating entities may be configured to monitor the channel to determine whether a higher priority operating entity is using the resources. If a lower priority operating entity determines through LBT or similar method that a higher priority operating entity is not going to use its G-INT resources, then the lower priority operating entities may attempt to access the resources on an opportunistic basis as described above.

In some examples, access to a G-INT or O-INT may be preceded by a reservation signal (e.g., request-to-send (RTS)/clear-to-send (CTS)), and the contention window (CW) may be randomly chosen between one and the total number of operating entities.

In some examples, an operating entity may employ or be compatible with coordinated multipoint (CoMP) communications. For example an operating entity may employ CoMP and dynamic time division duplex (TDD) in a G-INT and opportunistic CoMP in an O-INT as needed.

In the example illustrated in FIG. 3, each sub-interval 320 includes a G-INT for one of Operator A, B, or C. However, in some cases, one or more sub-intervals 320 may include resources that are neither reserved for exclusive use nor reserved for prioritized use (e.g., unassigned resources). Such unassigned resources may be considered an O-INT for any network operating entity, and may be accessed on an opportunistic basis as described above.

In some examples, each subframe 325 may contain 14 symbols (e.g., 250-μs for 60 kHz tone spacing). These subframes 325 may be standalone, self-contained Interval-Cs (ITCs) or the subframes 325 may be a part of a long ITC. An ITC may be a self-contained transmission starting with a downlink transmission and ending with an uplink transmission. In some embodiments, an ITC may contain one or more subframes 325 operating contiguously upon medium occupation. In some cases, there may be a maximum of eight network operators in an A-INT 310 (e.g., with duration of 2 ms) assuming a 250-μs transmission opportunity.

Although three operators are illustrated in FIG. 3, it should be understood that fewer or more network operating entities may be configured to operate in a coordinated manner as described above. In some cases, the location of the G-INT, O-INT, or A-INT within the superframe 305 for each operator is determined autonomously based on the number of network operating entities active in a system. For example, if there is only one network operating entity, each sub-interval 320 may be occupied by a G-INT for that single network operating entity, or the sub-intervals 320 may alternate between G-INTs for that network operating entity and O-INTs to allow other network operating entities to enter. If there are two network operating entities, the sub-intervals 320 may alternate between G-INTs for the first network operating entity and G-INTs for the second network operating entity. If there are three network operating entities, the G-INT and O-INTs for each network operating entity may be designed as illustrated in FIG. 3. If there are four network operating entities, the first four sub-intervals 320 may include consecutive G-INTs for the four network operating entities and the remaining two sub-intervals 320 may contain O-INTs. Similarly, if there are five network operating entities, the first five sub-intervals 320 may contain consecutive G-INTs for the five network operating entities and the remaining sub-interval 320 may contain an O-INT. If there are six network operating entities, all six sub-intervals 320 may include consecutive G-INTs for each network operating entity. It should be understood that these examples are for illustrative purposes only and that other autonomously determined interval allocations may be used.

It should be understood that the coordination framework described with reference to FIG. 3 is for illustration purposes only. For example, the duration of superframe 305 may be more or less than 20 ms. Also, the number, duration, and location of sub-intervals 320 and subframes 325 may differ from the configuration illustrated. Also, the types of resource designations (e.g., exclusive, prioritized, unassigned) may differ or include more or less sub-designations.

The air interface for 5G NR networks employs a lean-overhead design principle which helps to reduce the overhead associated with the “always-on” system RSs of 4^{th} Generation (4G) LTE networks. One difference between 5G NR and LTE is the replacement of the cell-specific reference signal (CRS) with UE-specific demodulation RS (DMRS) and channel state information RS (CSI-RS). In 5G NR, DMRS may be transmitted inside the frequency-time resource region of the scheduled physical downlink shared channel (PDSCH), while CSI-RS may be configured for CSI feedback for beam management and/or link adaptation, and for providing the UE with an RS that can be used to track DL frequency and timing drift. The CSI-RS used by UEs for tracking purpose may also be referred to as the tracking RS (TRS).

The synchronization signal block (SSB), transmitted in 5G NR systems, may be considered a remaining “always-on” RS, which may be regularly transmitted by gNBs with periodicity of 5 ms to 80 ms (typically 20 ms). In 5G NR systems, a UE will regularly track downlink frequency or time drift over time in order to maintain efficient and reliable communications. One means available for the UE to track such time or frequency drift is a time or frequency tracking loop operation. The tracking loop operation uses a known reference signal, such as SSB, TRS, and the like, for estimating the time or frequency errors to track the drift over time. In order for UEs to perform a tracking loop operation, TRS should be configured with sufficient time-domain density in order for UE to adequately estimate the time or frequency errors and track the downlink drift over time. Although not as frequent as LTE CRS, TRS may be configured and used as a supplement to SSB for tracking loop operations under most scenarios.

In certain existing 4G bands, the migration path towards 5G operations will go through a transition period in which both the legacy network (e.g., LTE) and the new, advanced network (e.g., NR)-capable UEs will be accessing the same communication spectrum. Shared access to the same communication spectrum can be achieved by setting the NR numerology to be the same as the LTE numerology (e.g., 15 kHz subcarrier spacing (SCS)) and making NR-specific resource elements (REs) agnostic to legacy LTE UEs. Such sharing by LTE and NR signals of the same time-frequency resource region may be referred to as dynamic spectrum sharing.

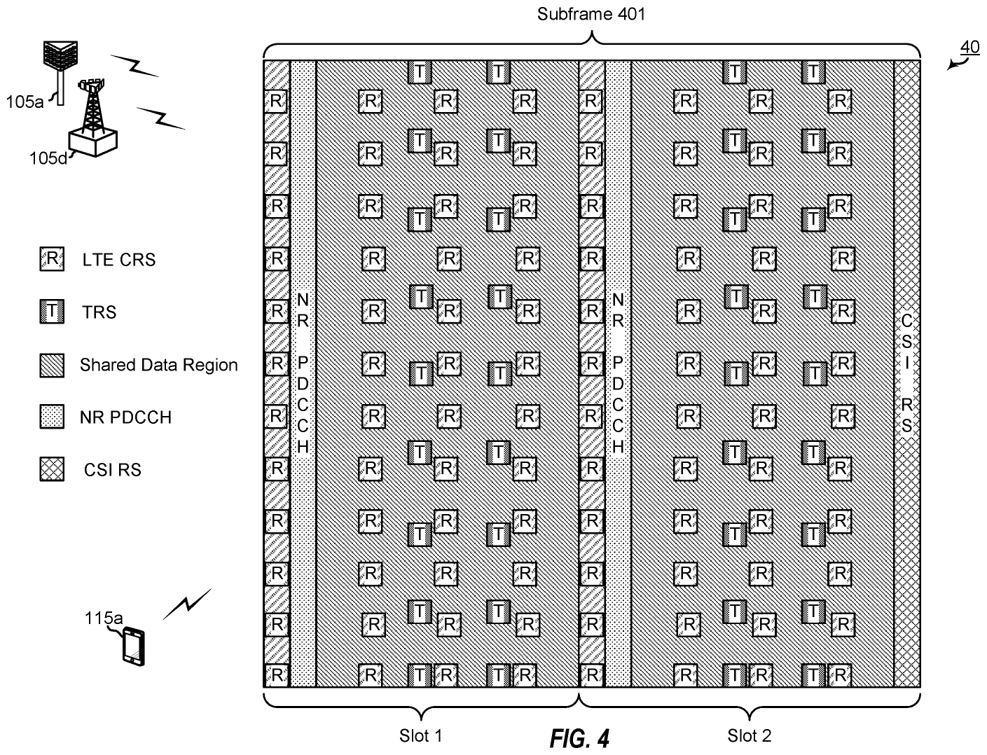

FIG. 4 is a block diagram illustrating a portion of a communication network 40 employing dynamic spectrum sharing between LTE operations and NR operations. FIG. 4 illustrates existing signaling for dynamically shared spectrum, but may also, as described in greater detail below, illustrate NR base station 105a, LTE base station 105d, and UE 115a, in configurations according to various aspects of the present disclosure. NR base station 105a provides NR communications and signaling for NR-capable UEs, such as UE 115a, while LTE base station 105d provides LTE communications and signaling. Both the NR operations and the LTE operations are shared over the same time-frequency resources. Subframe 401 of the shared time-frequency resources is illustrated with two slots (slot 1 and slot 2). Each slot of subframe 401 includes control regions (e.g., NR PDCCH) and a shared data region. Based on a scheduling grant, the shared data region and resources other than LTE- or NR-system-specific overhead can be used to serve data dynamically to LTE or NR-capable UEs, such as UE 115a. However, because LTE CRS is designed to be “always on” (or “regularly on” in multicast-broadcast single frequency network (MBSFN) subframes), it cannot be reused as NR REs. Although some networks may turn off LTE CRS signaling as a power saving feature. This forces legacy LTE UEs to rely on energy detection to adapt its CRS processing accordingly. Imposing any non-zero NR power on those CRS REs would not be considered backward-compatible to the legacy LTE UEs. In contrast, the NR signals, e.g., TRS and CSI RS, can be configured with flexibility. Subframe 401, as illustrated, ends with NR CSI-RS.

In dynamically shared spectrum deployments, the 5G air interface is configured to provide an indication to NR-capable UEs, such as UE 115a, of the location and pattern of the LTE CRS REs within NR slots. Subframe 401, with slots 1 and 2, may support NR-capable UE, UE 115a. UE 115a supports may further support rate matching around LTE CRS. Accordingly, the shared data region (e.g., PDSCH resource region) allocated to UE 115a is illustrated to include LTE CRS REs from LTE base station 105d. Upon receiving the indication from NR base station 105a of the location and pattern of the LTE CRS REs, UE 115a may then rate match or puncture the REs corresponding to the LTE CRS from the data region demodulation and decoding process. Thus, the LTE CRS information will not cause interference to the NR data received in the shared data region. Additionally, NR base station 105a may also transmit TRS at appropriate intervals as illustrated in subframe 401. UE 115a may use these TRS to perform tracking loop operations to monitor any downlink time or frequency drift. Thus, spectrum sharing between LTE and NR systems can be achieved.

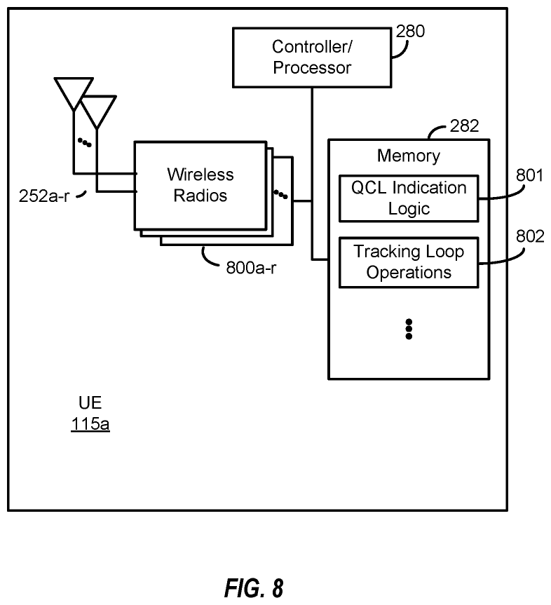

FIG. 5 is a block diagram illustrating example blocks executed to implement aspects of the present disclosure. The example blocks will also be described with respect to UE 115a as illustrated in FIG. 8. FIG. 8 is a block diagram illustrating UE 115a configured according to one aspect of the present disclosure. UE 115 includes the structure, hardware, and components as illustrated for UE 115a of FIG. 2. For example, UE 115a includes controller/processor 280, which operates to execute logic or computer instructions stored in memory 282, as well as controlling the components of UE 115a that provide the features and functionality of UE 115a. UE 115a, under control of controller/processor 280, transmits and receives signals via wireless radios 800a-r and antennas 252a-r. Wireless radios 800a-r includes various components and hardware, as illustrated in FIG. 2 for UE 115, including modulator/demodulators 254a-r, MIMO detector 256, receive processor 258, transmit processor 264, and TX MIMO processor 266.

At block 500, the UE obtains a colocation indication identifying a QCL status of a legacy network downlink antenna associated with transmission of one or more CRS REs and an advanced network downlink antenna in communication with the UE, wherein the advanced network and a legacy network dynamically share the time-frequency resources. The various aspects of the present disclosure provide for reuse of the LTE CRS REs as an NR in-band TRS when a UE, such as UE 115a, has knowledge that both the LTE network and NR network downlink transmit antennas are from the same radio frequency (RF) chain with co-located antennas. Such a relationship is equivalent to the quasi-colocation of the LTE and NR base stations. Identifying the QCL status between the legacy network (e.g., the LTE network operations) and the advanced network (e.g., the 5G NR network operations) may be accomplished according to the various aspects of the present disclosure either with existing implementations and information that can be used by UE 115a to determine the QCL status or by revising the wireless standards for the advanced network with additional information and techniques specifically for identifying the QCL status. UE 115a, under control of controller/processor 280, would execute QCL indication logic 801, in memory 282. The execution environment of QCL indication logic 801 would use whichever example aspect, whether using current implementation or modified standards, to obtain an indication of QCL status. The QCL status may either be indicated as a QCL state, which indicates that the legacy network downlink antennas are quasi-colocated with the advanced network downlink antennas, or not QCL.

Example aspects provided within the execution environment of QCL indication logic 801 that do not require modifying the wireless standards include, for example, each begin to obtain the QCL status information by the NR-capable UE detecting the presence of LTE CRS REs within the NR time-frequency resources. When LTE CRS REs are detected via antennas 252a-r and wireless radios 800a-r within the NR time-frequency resource set, then for example, where all network deployments may be known in advance to be based on shared remote radio units (RRUs) and shared antennas, the UE would indicate the QCL status as an QCL state by default. Alternatively, the QCL status may be determined based on a higher-layer indications obtained by the UE through specific network identifiers, such as a combination of mobile country code (MCC), mobile network code (MNC), or cell ID. Where such specific network identifiers suggest the network operations are quasi-colocated, the UE indicates the QCL status as a QCL state. The QCL status may further be obtained by the UE through use of one or a combination of the NR configuration signal of LTE CRS location and the NR configuration of an LTE CRS-like CSI-RS location and pattern.

Other example aspects provided within the execution environment of QCL indication logic 801 that include modifications to the wireless standards include, for example, modifying the payload of the NR configuration signal that identifies the location of any LTE CRS REs to include a field that designates whether the legacy network downlink antennas are quasi-colocated with the advanced network downlink antennas. Such a field would identify the QCL status. Alternatively, a standards modification may be made that allows the NR configuration of a CSI-RS resource set to include an LTE CRS pattern to be used for tracking. Thus, the NR configuration of the CSI-RS resource set for tracking may be defined, using row-2 type configuration, to reflect an LTE CRS pattern. Such configuration signaling would include an indicator that such an LTE CRS pattern for the CSI-RS may be used for tracking as a TRS. In a further alternative example aspect, a configuration of an NR CSI-RS resource set without a purpose may be allowed to include configuration of a LTE CRS pattern. The NR-capable UE may then use the NR configuration that identifies the location of the LTE CRS REs to determine QCL status when the pattern and location identified in the NR CSI-RS resource set matches the pattern and location of the LTE CRS REs identified in the NR configuration. In such alternative aspect, the NR CSI-RS configuration includes either no reporting configuration or a reporting configuration set to “none.” This identifies to the UE to compare the resource set allocated for the NR CSI-RS with the resource set identified for the LTE CRS REs. When the two resource sets are identical, the UE may indicate the QCL status as a QCL state.

At block 502, the UE performs a tracking loop operation for the advanced network using the one or more CRS REs of the legacy network in response to the QCL status indicating a QCL state, wherein the QCL state indicates the legacy network downlink antenna is quasi-colocated with the advanced network downlink antenna. For example, under control of controller/processor 280, UE 115a executes tracking loop operations 802, in memory 282. The execution environment of tracking loop operations 802 provides UE 115a with the functionality for performing either frequency or time tracking loops for the NR operations. In order to track downlink time or frequency drift over time for the NR network, within the execution environment of tracking loop operations 802, UE 115a may use the LTE CRS REs to perform NR tracking loop operations. Because such LTE signals are reused for NR TRS, the NR base station would not have to separately transmit TRS, thus, further saving NR overhead.

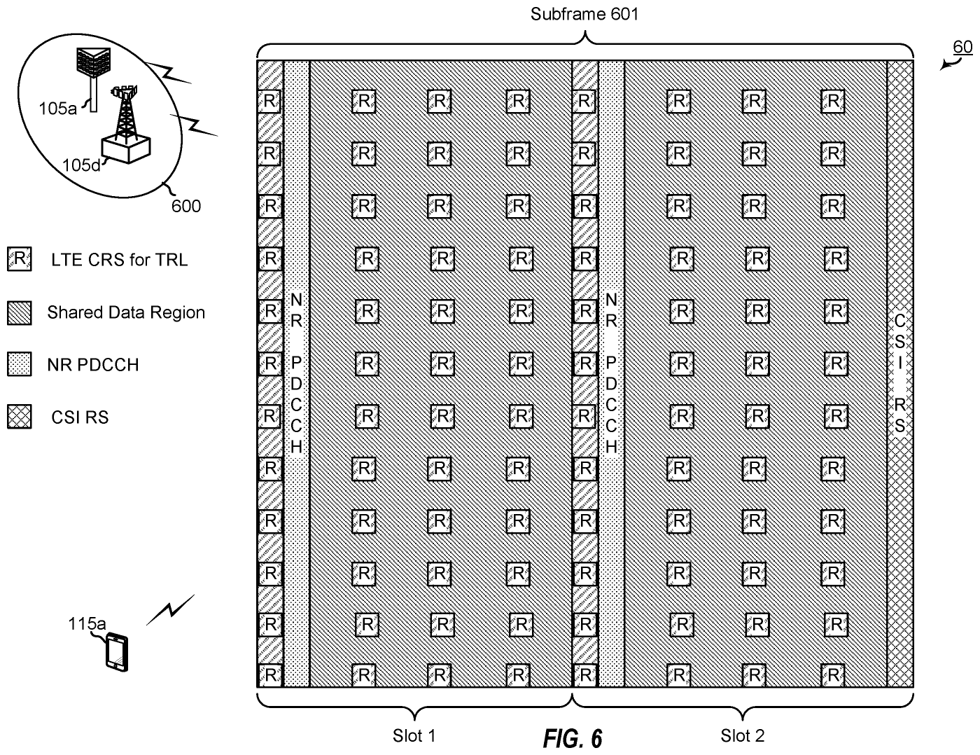

FIG. 6 is a block diagram illustrating a portion of a communication network 60 employing dynamic spectrum sharing between LTE operations and NR operations conducted by NR base station 105a, LTE base station 105d, and an NR-compatible UE, UE 115a, each configured according to one aspect of the present disclosure. NR base station 105a provides NR communications and signaling for NR-capable UEs, such as UE 115a, while LTE base station 105d provides LTE communications and signaling. Both the NR operations and the LTE operations are shared over the same time-frequency resources. Subframe 601 of the time-frequency resources is illustrated with two slots (slot 1 and slot 2). Each slot of subframe 601 includes control regions (e.g., NR PDCCH) and a shared data region and ends with the NR CSI-RS.

According to the illustrated aspect of the present disclosure, reuse of LTE CRS as an NR in-band TRS is proposed wherever the NR-compatible UE, UE 115a, has the knowledge that the LTE and NR downlink transmit antennas are from the same RF chain with co-located antennas. This relationship is equivalent to QCL Type-C (e.g., Doppler shift, average delay) or Type-B (e.g., Doppler shift, Doppler spread) indication specified for 5G NR operations. As illustrated, NR base station 105a and LTE base station 105d are quasi-colocated, QCL 600. The QCL status of the LTE and NR downlink antennas may be obtained according to the various aspects of the present disclosure either using existing implementations and information that can be used by the UE to determine the QCL status or by revising the wireless standards for the advanced network with additional information and techniques specifically for identifying the QCL status. Based on the knowledge of this QCL status information, UE 115a may treat the LTE CRS illustrated within the shared data regions of slots 1 and 2 of subframe 601 as NR TRS. UE 115a may then run its frequency and/or time tracking loops using the LTE CRS RE samples as if, such LTE CRS REs were part of the NR air interface.

In a first set of example aspects, the QCL status information can be obtained by UE 115a via a number of different methods or combinations thereof involving existing implementations and information. For example, upon identifying the presence of LTE CRS REs within the NR time-frequency resources, UE 115a may, by default, assume the QCL status is a collocated QCL state (e.g., apply QCL Type-C/Type-B) for the LTE CRS samples when all network deployments are known to be based on shared RRUs and shared antennas. Alternatively, upon identifying the presence of LTE CRS REs within the NR time-frequency resources, UE 115b may determine the QCL status based on higher-layer indications with specific network identifiers, such as a combination of MCC and MNC, or the cell ID. When such higher-layer indications suggest a list of known network deployments are based on shared RRU and antennas, UE 115a may set the LTE CRS QCL status to be TRUE (e.g., the QCL state). UE 115a may then use the LTE CRS RE samples as NR TRS input to its tracking loop operations accordingly.

In a further alternative implementation, upon identifying the presence of the LTE CRS REs within the NR time-frequency resources, UE 115a may implicitly determine QCL status from the configuration of an NR NZP CSI-RS resource set configured by NR base station 105a. NR base station 105a uses row-2 type configuration of the NR CSI-RS pattern in RRC configuration for UE 115a, in lieu of or along with the information element that informs UE 115a of the LTE CRS location and configuration (e.g., RateMatchPatternLTE-CRS). UE 115a may then use these specifically formed CSI-RS sets that correspond to the locations for the LTE CRS REs for the tracking loop operations.

Regardless of the method of obtaining the QCL status with existing implementations and information, UE 115a may determine the existence or presence of the LTE CRS within the NR time-frequency resources using various explicit or implicit methods. For example, presence of the LTE CRS may be explicitly identified via the RRC configuration in either the NR cell common or dedicated bandwidth part. The location and configuration of the LTE CRS may be signaled by an information element in the RRC configuration (e.g., RateMatchPatternLTE-CRS). Alternatively, NR base station 105a may provide an LTE CRS-like pattern using a row-2 configured ZP CSI-RS pattern. UE 115a would perform row-2 ZP CSI-RS pattern matching under the dynamic spectrum sharing frequency band RRC configuration to detect whether an LTE CRS has been implicitly indicated by NR base station 105a. When the existence or presence of LTE CRS REs within the NR time-frequency resource is identified, UE 115a may perform LTE CRS detection to determine whether the LTE CRS operations are active or not. If UE 115a determines that the LTE CRS operations are active, it may then properly reuse the LTE CRS REs for its tracking loop operations. Thus, when the LTE stack is active concurrently with the NR stack (e.g., as E-UTRAN NR dual connectivity (EN-DC) or multi-subscriber-ID-module (MSIM) operations), and UE 115a has identified LTE CRS within the NR time-frequency resource, the NR stack of UE 115a can use the tracking loop from the LTE stack as a substitute of its own.

In a second set of example aspects, the QCL status information can be obtained by UE 115a via a number of different methods or combinations thereof involving modification of the wireless standards for the advanced network with additional information and techniques specifically for identifying the QCL status. For example, the payload of the NR configuration signal that identifies the location of any LTE CRS REs (e.g., RateMatchPatternLTE-CRS) may be modified to include a field that designates whether the legacy network downlink antennas are quasi-colocated with the advanced network downlink antennas. Such a field would explicitly identify the QCL status. Thus, when NR base station 105a sends the RRC configuration including the IE defining the location and configuration of the LTE CRS REs, an additional field in this IE identifies the QCL status. As illustrated, NR base station 105a is QCL 600 with LTE base station 105d. Accordingly, the QCL status field indicates the QCL state. UE 115a, upon receiving the RRC configuration with QCL status field, it may know that it can reuse the LTE CRS REs. If the NR network, NR base station 105a, does not signal an indication of the QCL state when the network standards have explicitly defined such operation, then UE 115a will not assume QCL 600. If the indication does not suggest the QCL state, UE 115a will deduce from the absence of this QCL status information that the antennas are not colocated.

Alternatively, a standards modification may be made that allows the NR configuration of a CSI-RS resource set for tracking to include an LTE CRS pattern. Thus, NR base station 105a transmits the NR configuration of the CSI-RS resource set for tracking (TRS) to UE 115a which includes a pattern, defined using row-2 type configuration, that reflects an LTE CRS pattern. This configuration signaling would further include an indicator that such an LTE CRS pattern may be used as a TRS. Thus, UE 115a may read the TRS resource set configuration that allows UE 115a to use the LTE CRS pattern for tracking. Based on this information, UE 115a determines an indication of the QCL status to be a QCL state.

In an additional aspect, a standards modification may allow a NR CSI-RS resource set configuration without any given purpose (e.g., tracking or otherwise) to include an LTE CRS pattern. This configuration in combination with the existing NR configuration that identifies the location of the LTE CRS REs may be used by UE 115a to determine an indication of the QCL status. In such alternative aspect, NR base station 105a includes either no reporting configuration or a reporting configuration set to “none” with the NR CSI-RS configuration that includes a LTE CRS RE pattern. This information may prompt the UE 115a to compare the resource set allocated for the NR CSI-RS with the resource set identified for the LTE CRS REs. When the two resource sets are identical, UE 115a may determine an indication of the QCL status as a QCL state.

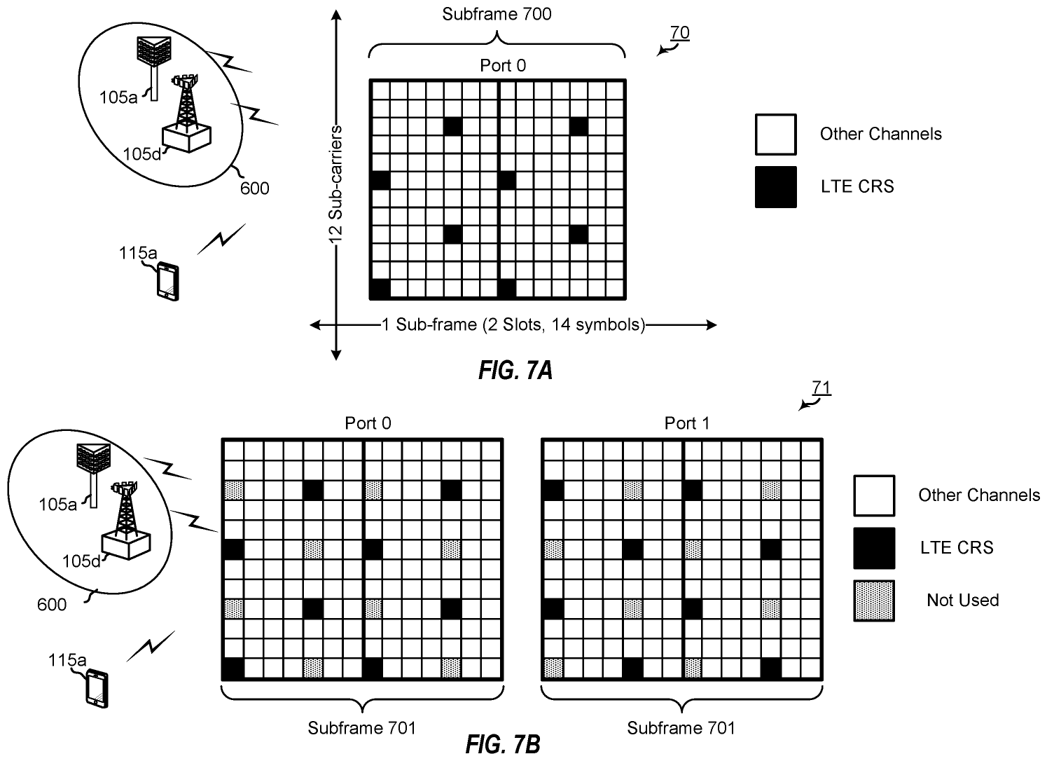

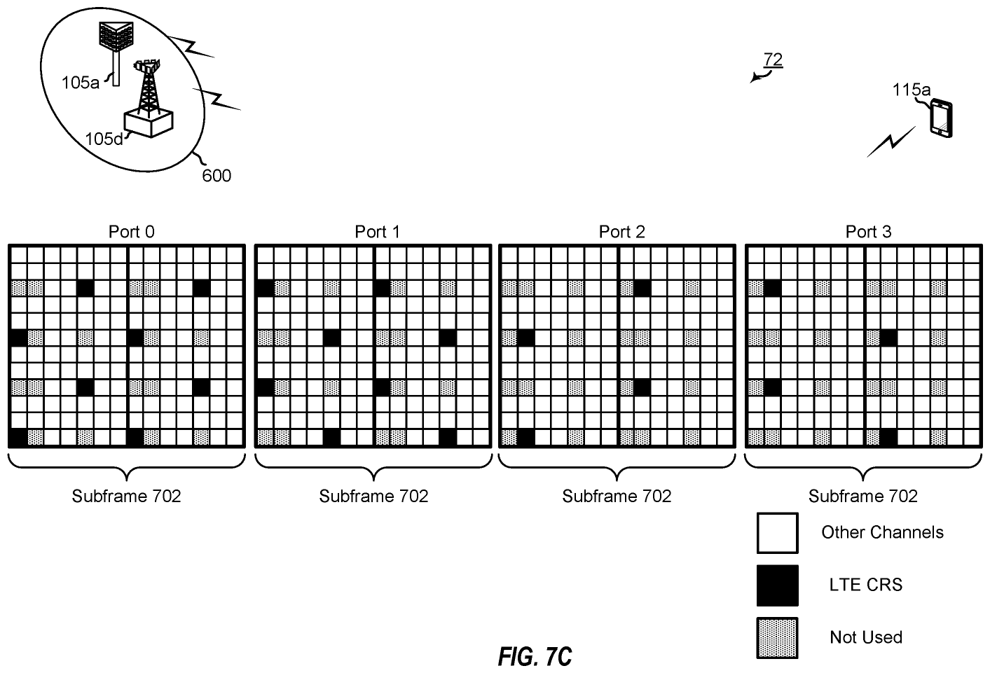

FIGS. 7A-7C are block diagrams illustrating portions of communication networks 70-72 employing dynamic spectrum sharing between LTE operations and NR operations conducted by NR base station 105a, LTE base station 105d, and an NR-compatible UE, UE 115a, each configured according to one aspect of the present disclosure. Within each illustrated portion of communication networks 70-72, a different number of antenna ports are used for communications. As illustrated, subframes 700 (FIG. 7A), 701 (FIG. 7B), and 702 (FIG. 7C) are non-MB SFN subframes. Where UE 115a determines that LTE CRS REs are present within the NR time-frequency resource of non-MB SFN subframes 700 (FIG. 7A), 701 (FIG. 7B), or 702 (FIG. 7C) and determines or identifies that NR base station 105a and LTE base station 105d are QCL, then UE 115a may use any of the LTE CRS REs in tracking loop operations to monitor frequency or time drift over time.

With reference to FIG. 6, when the NR spectrum is dynamically shared with LTE operations, and the infrastructure of NR base station 105a and LTE base station 105d are QCL 600, NR base station 105a would not need to configure additional TRS resources for UEs, such as UE 115a, configured according to aspects of the present disclosure. When only such configured UEs are served, NR base station 105a would not have to generate TRS signals within the shared data region for tracking operations. Thus, the NR system efficiency is improved with lower overhead.

With reference to FIG. 4, alternatively, where some NR-compatible UEs are not configured according to aspects of the present disclosure and do not reuse the in-band LTR CRS for tracking loop operations, the UEs configured according to the aspects of the present disclosure, such as UE 115a, can improve tracking loop performance by incorporating the LTE CRS REs along with the NR TRS, which would effectively enhance the TRS density. Similarly, for UEs operating under discontinuous receive (DRX) modes, the ability to reuse LTE CRS for NR tracking loop operations enables such UEs to wake up over a much shorter ON duration. Because of the “always-on” nature of the LTE CRS, there would be 4 LTE CRS symbols within every 14 symbols of each non-MB SFN subframe (1 ms). Such UEs would not need to either wake up for TRS symbols that are not aligned with its ON duration or look for NR SSBs that can be up to 10 ms away. These DRX mode UEs may derive benefit according to the various aspects of the present disclosure in either the scenario of FIG. 4, where NR base station 105a transmits TRS signals, or the scenario of FIG. 6, where the compatible UEs, such as UE 115a, are able to use the LTE CRS signaling for the NR tracking loop operations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIG. 5 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various aspects of the present disclosure may be implemented in many different ways, including methods, processes, non-transitory computer-readable medium having program code recorded thereon, apparatus having one or more processors with configurations and instructions for performing the described features and functionality, and the like. A first aspect configured for wireless communication may include obtaining, by a UE compatible with an advanced network, a colocation indication identifying a QCL status of a legacy network downlink antenna associated with transmission of one or more CRS REs and an advanced network downlink antenna in communication with the UE, wherein the advanced network and a legacy network dynamically share the time-frequency resources; and performing, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

A second aspect, based on the first aspect, wherein the obtaining the colocation indication includes determining, by the UE, presence of the one or more CRS REs of the legacy network within a time-frequency resource of the advanced network.

A third aspect, based on the second aspect, wherein the determining the presence of the one or more CRS REs includes one of: receiving a resource configuration signal identifying a pattern for the one or more CRS REs of the legacy network; or receiving special resource set configuration of an advanced network TRS, wherein the special resource set configuration identifies a resource pattern associated with the one or more CRS UEs of the legacy network.

A fourth aspect, based on the second aspect, wherein the obtaining the colocation indication further includes one of: determining the QCL status as the QCL state by default in response to predefined information that all network deployments use shared RRUs and shared antennas; or receiving, by the UE, a higher-layer indication signal with one or more identifiers indicating the QCL status as one of: the QCL state, or a not QCL state.

A fifth aspect, based on the fourth aspect, wherein the one or more identifiers includes one or more of: a MCC, a MNC, and a cell ID.

A sixth aspect, based on the second aspect, wherein the obtaining the colocation indication further includes: receiving a special resource set configuration of an advanced network TRS, wherein the special resource set configuration identifies a resource pattern associated with the one or more CRS UEs of the legacy network; and determining the QCL status as the QCL state in response to the special resource set configuration.

A seventh aspect, based on the first aspect, wherein the obtaining the colocation indication includes: receiving an advanced resource configuration signal identifying a resource pattern of the one or more CRS REs and including a QCL field identifying the QCL status; and determining the QCL status as the QCL state in response to the QCL field indicating the QCL state.

An eighth aspect, based on the first aspect, wherein the obtaining the colocation indication includes: receiving a resource set configuration of the advanced network TRS identifying a TRS pattern identical to a resource pattern of the one or more CRS REs; and determining the QCL status as the QCL state when the TRS pattern identified is identical to the resource pattern of the one or more CRS REs.

A ninth aspect, based on the first aspect, wherein the obtaining the colocation indication includes: receiving a resource configuration signal identifying a resource pattern of the one or more CRS REs of the legacy network; receiving a special resource set configuration of an advanced network CSI-RS, wherein the special resource set configuration identifies the resource pattern identical of the one or more CRS UEs; and determining the QCL status as the QCL state in response to the special resource set of the advanced network CSI-RS matching the resource pattern of the one or more CRS UEs.

A tenth aspect, based on the first aspect, further including: determining, by the UE in response to determination of the presence, a legacy network air interface and an advanced network air interface are concurrently active, wherein the performing the tracking loop operation is triggered in response to the legacy network air interface and the advanced network air interface being concurrently active.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
obtaining, by a user equipment (UE) compatible with an advanced network, a colocation indication identifying a quasi-colocation (QCL) status of a legacy network downlink antenna associated with transmission of one or more cell-specific reference signal (CRS) resource elements (REs) and an advanced network downlink antenna in communication with the UE, wherein the advanced network and a legacy network dynamically share the time-frequency resources; and
performing, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

2. The method of claim 1, wherein the obtaining the colocation indication includes determining, by the UE, presence of the one or more CRS REs of the legacy network within a time-frequency resource of the advanced network.

3. The method of claim 2, wherein the determining the presence of the one or more CRS REs includes one of:
receiving a resource configuration signal identifying a pattern for the one or more CRS REs of the legacy network; or
receiving special resource set configuration of an advanced network tracking purpose resource signal (TRS), wherein the special resource set configuration identifies a resource pattern associated with the one or more CRS UEs of the legacy network.

4. The method of claim 2, wherein the obtaining the colocation indication further includes one of:
determining the QCL status as the QCL state by default in response to predefined information that all network deployments use shared remote radio units (RRUs) and shared antennas; or
receiving, by the UE, a higher-layer indication signal with one or more identifiers indicating the QCL status as one of: the QCL state, or a not QCL state.

5. The method of claim 4, wherein the one or more identifiers includes one or more of:
a mobile country code (MCC);
a mobile network code (MNC), and
a cell identifier (ID).

6. The method of claim 2, wherein the obtaining the colocation indication further includes:
receiving a special resource set configuration of an advanced network tracking purpose resource signal (TRS), wherein the special resource set configuration identifies a resource pattern associated with the one or more CRS UEs of the legacy network; and
determining the QCL status as the QCL state in response to the special resource set configuration.

7. The method of claim 1, wherein the obtaining the colocation indication includes:
receiving an advanced resource configuration signal identifying a resource pattern of the one or more CRS REs and including a QCL field identifying the QCL status; and
determining the QCL status as the QCL state in response to the QCL field indicating the QCL state.

8. The method of claim 1, wherein the obtaining the colocation indication includes:
receiving a resource set configuration of the advanced network tracking purpose resource signal (TRS) identifying a TRS pattern identical to a resource pattern of the one or more CRS REs; and
determining the QCL status as the QCL state when the TRS pattern identified is identical to the resource pattern of the one or more CRS REs.

9. The method of claim 1, wherein the obtaining the colocation indication includes:
receiving a resource configuration signal identifying a resource pattern of the one or more CRS REs of the legacy network;
receiving a special resource set configuration of an advanced network channel state information resource signal (CSI-RS), wherein the special resource set configuration identifies the resource pattern identical of the one or more CRS UEs; and
determining the QCL status as the QCL state in response to the special resource set of the advanced network CSI-RS matching the resource pattern of the one or more CRS UEs.

10. The method of claim 1, further including:
determining, by the UE in response to determination of the presence, a legacy network air interface and an advanced network air interface are concurrently active, wherein the performing the tracking loop operation is triggered in response to the legacy network air interface and the advanced network air interface being concurrently active.

11. An apparatus configured for wireless communication, comprising:
means for obtaining, by a user equipment (UE) compatible with an advanced network, a colocation indication identifying a quasi-colocation (QCL) status of a legacy network downlink antenna associated with transmission of one or more cell-specific reference signal (CRS) resource elements (REs) and an advanced network downlink antenna in communication with the UE, wherein the advanced network and a legacy network dynamically share the time-frequency resources; and
means for performing, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

12. The apparatus of claim 11, wherein the means for obtaining the colocation indication includes means for determining, by the UE, presence of the one or more CRS REs of the legacy network within a time-frequency resource of the advanced network.

13. The apparatus of claim 12, wherein the means for determining the presence of the one or more CRS REs includes one of:
means for receiving a resource configuration signal identifying a pattern for the one or more CRS REs of the legacy network; or
means for receiving special resource set configuration of an advanced network tracking purpose resource signal (TRS), wherein the special resource set configuration identifies a resource pattern associated with the one or more CRS UEs of the legacy network.

14. The apparatus of claim 12, wherein the means for obtaining the colocation indication further includes one of:
means for determining the QCL status as the QCL state by default in response to predefined information that all network deployments use shared remote radio units (RRUs) and shared antennas; or
means for receiving, by the UE, a higher-layer indication signal with one or more identifiers indicating the QCL status as one of: the QCL state, or a not QCL state.

15. The apparatus of claim 14, wherein the one or more identifiers includes one or more of:
a mobile country code (MCC);
a mobile network code (MNC), and
a cell identifier (ID).

16. The apparatus of claim 12, wherein the means for obtaining the colocation indication further includes:
means for receiving a special resource set configuration of an advanced network tracking purpose resource signal (TRS), wherein the special resource set configuration identifies a resource pattern associated with the one or more CRS UEs of the legacy network; and
means for determining the QCL status as the QCL state in response to the special resource set configuration.

17. The apparatus of claim 11, wherein the means for obtaining the colocation indication includes:
means for receiving an advanced resource configuration signal identifying a resource pattern of the one or more CRS REs and including a QCL field identifying the QCL status; and
means for determining the QCL status as the QCL state in response to the QCL field indicating the QCL state.

18. The apparatus of claim 11, wherein the means for obtaining the colocation indication includes:
means for receiving a resource set configuration of the advanced network tracking purpose resource signal (TRS) identifying a TRS pattern identical to a resource pattern of the one or more CRS REs; and
means for determining the QCL status to the QCL state when the TRS pattern identified is identical to the resource pattern of the one or more CRS REs.

19. The apparatus of claim 11, wherein the means for obtaining the colocation indication includes:
means for receiving a resource configuration signal identifying a resource pattern of the one or more CRS REs of the legacy network;
means for receiving a special resource set configuration of an advanced network channel state information resource signal (CSI-RS), wherein the special resource set configuration identifies the resource pattern identical of the one or more CRS UEs; and
means for determining the QCL status as the QCL state in response to the special resource set of the advanced network CSI-RS matching the resource pattern of the one or more CRS UEs.

20. The apparatus of claim 11, further including:
means for determining, by the UE in response to indication of the QCL status, a legacy network air interface and an advanced network air interface are concurrently active, wherein the means for performing the tracking loop operation is triggered in response to the legacy network air interface and the advanced network air interface being concurrently active.

21. An apparatus configured for wireless communication, the apparatus comprising:
at least one processor; and
a memory coupled to the at least one processor,
wherein the at least one processor is configured:
to obtain, by a user equipment (UE) compatible with an advanced network, a colocation indication identifying a quasi-colocation (QCL) status of a legacy network downlink antenna associated with transmission of one or more cell-specific reference signal (CRS) resource elements (REs) and an advanced network downlink antenna in communication with the UE, wherein the advanced network and a legacy network dynamically share the time-frequency resources; and
to perform, by the UE, a tracking loop operation for the advanced network by re-using the one or more CRS REs of the legacy network in response to the QCL status indicating a QCL state, wherein the QCL state indicates the legacy network downlink antenna is quasi-colocated with the advanced network downlink antenna.

22. The apparatus of claim 21, wherein the configuration of the at least one processor to obtain the colocation indication includes configuration of the at least one processor to determine, by the UE, presence of the one or more CRS REs of the legacy network within a time-frequency resource of the advanced network.

23. The apparatus of claim 22, wherein the configuration of the at least one processor to determine the presence of the one or more CRS REs includes configuration of the at least one processor to one of:
receive a resource configuration signal identifying a pattern for the one or more CRS REs of the legacy network; or
receive special resource set configuration of an advanced network tracking purpose resource signal (TRS), wherein the special resource set configuration identifies a resource pattern associated with the one or more CRS UEs of the legacy network.

24. The apparatus of claim 22, wherein the configuration of the at least one processor to obtain the colocation indication further includes configuration of the at least one processor to one of:
determine the QCL status as the QCL state by default in response to predefined information that all network deployments use shared remote radio units (RRUs) and shared antennas; or
receive, by the UE, a higher-layer indication signal with one or more identifiers indicating the QCL status as one of: the QCL state, or a not QCL state.

25. The apparatus of claim 24, wherein the one or more identifiers includes one or more of:
a mobile country code (MCC);
a mobile network code (MNC), and
a cell identifier (ID).

26. The apparatus of claim 22, wherein the configuration of the at least one processor to obtain the colocation indication further includes configuration of the at least one processor:
to receive a special resource set configuration of an advanced network tracking purpose resource signal (TRS), wherein the special resource set configuration identifies a resource pattern associated with the one or more CRS UEs of the legacy network; and
to determine the QCL status as the QCL state in response to the special resource set configuration.

27. The apparatus of claim 21, wherein the configuration of the at least one processor to obtain the colocation indication includes configuration of the at least one processor:
to receive an advanced resource configuration signal identifying a resource pattern of the one or more CRS REs and including a QCL field identifying the QCL status; and
to determine the QCL status as the QCL state in response to the QCL field indicating the QCL state.

28. The apparatus of claim 21, wherein the configuration of the at least one processor to obtain the colocation indication includes configuration of the at least one processor:
to receive a resource set configuration of the advanced network tracking purpose resource signal (TRS) identifying a TRS pattern identical to a resource pattern of the one or more CRS REs; and
to determine the QCL status to the QCL state when the TRS pattern identified is identical to the resource pattern of the one or more CRS REs.

29. The apparatus of claim 21, wherein the configuration of the at least one processor to obtain the colocation indication includes configuration of the at least one processor:
to receive a resource configuration signal identifying a resource pattern of the one or more CRS REs of the legacy network;
to receive a special resource set configuration of an advanced network channel state information resource signal (CSI-RS), wherein the special resource set configuration identifies the resource pattern identical of the one or more CRS UEs; and
to determine the QCL status as the QCL state in response to the special resource set of the advanced network CSI-RS matching the resource pattern of the one or more CRS UEs.

30. The apparatus of claim 21, further including configuration of the at least one processor to determine, by the UE in response to indication of the QCL status, a legacy network air interface and an advanced network air interface are concurrently active, wherein the configuration of the at least one processor to perform the tracking loop operation is triggered in response to the legacy network air interface and the advanced network air interface being concurrently active.
